(19) United States
(12) Patent Application Publication
(10) Pub. No.: US 2011/0155606 A1
(43) Pub. Date: Jun. 30, 2011

(54) Scented Label

(75) Inventors: Barron G. McKillip, Mickleton, NJ (US); Ulrich E. Weyermann, Bethany Beach, DE (US); Allan MacKinlay, Maple Glen, PA (US); David DeCord, Mt. Laurel, NJ (US)

(73) Assignee: Sancoa International Company, L.P., Lumberton, NJ (US)

(21) Appl. No.: 12/957,804

(22) Filed: Dec. 1, 2010

Related U.S. Application Data
(60) Provisional application No. 61/265,919, filed on Dec. 2, 2009.

(51) Int. Cl. B65D 85/00; B41M 5/00; B32B 37/00

(52) U.S. Cl. 206/459.5; 428/195.1; 156/306.3

(57) ABSTRACT

The present invention embraces a scented label and methods of producing and using the same. The label of the invention is composed of a base layer, a scented thermoplastic layer, and a removable protective barrier layer which blocks release of the scent from the thermoplastic layer until desired by a consumer.

This application claims benefit of priority to U.S. Provisional Application Ser. No. 61/265,919, filed Dec. 2, 2009, the content of which is incorporated herein by reference in its entirety.

### INTRODUCTION

### BACKGROUND OF THE INVENTION

Labels are applied to packages to build brand awareness, show the contents of the package, convey a quality message regarding the contents of a package and supply consumer information such as directions on product use, or an ingredient listing of the contents. The three types of information applied to a label are text, graphic and images. There is a continuing need for further improving the quality of labels and the advertising power of the same.

The use of scents with media (images and text) is a very familiar marketing tool. Magazines have used scents to entice customers by enabling sampling or by association of the scent with a product. In this respect, the use of scents and images has been developed to support business strategies. U.S. Pat. No. 5,318,327 provides for a card that has a scent-receiving zone and a greeting message receiving zone. U.S. Pat. No. 5,398,070 teaches the capture of images with scene scents and subsequent image display and scent emission device. The association of scents in other media, such as photographic (U.S. Pat. No. 5,995,770) media and electrophotographic (U.S. Pat. No. 5,970,300) media, is a more recent development. U.S. Pat. No. 5,995,770 teaches the photographers' selection of scent for application to photographic images using a variety of delivery subsystems such as micro-encapsulation (scratch and sniff), poly-traps, microsponges as well as direct spraying of aerosol scents onto the back of a photographic print. U.S. Pat. No. 5,970,300 teaches the method of application of liquid scents to a typical electrophotographic process. U.S. Pat. No. 6,755,350 further teaches a sensual pressure sensitive adhesive label containing an image having at least one overcoat layer over said image wherein said overcoat layer contains at least one tactile or olfactory feature and is composed of a mixture of vinyl polymer and urethane polymer. US Patent Application No. 20080295457 also discloses fragrance tagging of products and fragrance enhanced products.

In addition, fragrances have been provided in thermoplastic beads held in a special compartment attached to the bottom of a container. Such compartments are held in place by two clear adhesive labels on the sides of the container, wherein a removable label is affixed to both the front and back of the container (FIG. 1). This type of container construction is very expensive as it requires container redesign, assembly and the need for four additional labels.

Therefore, there is a need for more cost effective ways of providing a fragranced container. The instant invention meets this need in the art by providing a scented label that can be applied with the same equipment used in the conventional application of labels to containers.

### SUMMARY OF THE INVENTION

The present invention features a pressure sensitive label composed of a base layer, a layer of scented thermoplastic applied to the upper surface of the base layer and a removable, protective barrier layer applied to the upper surface of the scented thermoplastic layer. In some embodiments, the base layer and/or protective barrier layer includes text, a graphic or image. Methods for producing a scented pressure sensitive label and a scented container optionally containing a shrink sleeve are also provided.

### BRIEF DESCRIPTION OF THE DRAWINGS

FIG. 1 depicts a prior art method for supplying fragrance on a container. In this approach, a special compartment is supplied on the bottom of the container (FIGS. 1A). When viewed from the bottom (FIG. 1B), thermoplastic beads in the special compartment are evident. A tab is removed from the compartment to allow the fragrance to emanate through holes (FIG. 1C).

FIG. 2 is a cross sectional view of the scented label construction, wherein a thick layer of scented thermoplastic is sandwiched between a pressure sensitive base label and a removable protective laminate. In one embodiment, the label does not contain any text or decoration (FIG. 2A). In another embodiment, the base layer and/or protective barrier layer contain text, a graphic and/or image (FIG. 2B).

FIG. 3 shows the incorporation of a fragrance into label construction according to the present invention. The product is initially provided with a label displaying product information (FIG. 3A). An easy peel tab allows the consumer to remove the protective outer layer exposing the fragrance on the base label (FIG. 3B).

FIG. 4 shows a container in which the label has been applied to the container and the protective shrink sleeve has been applied over the container.

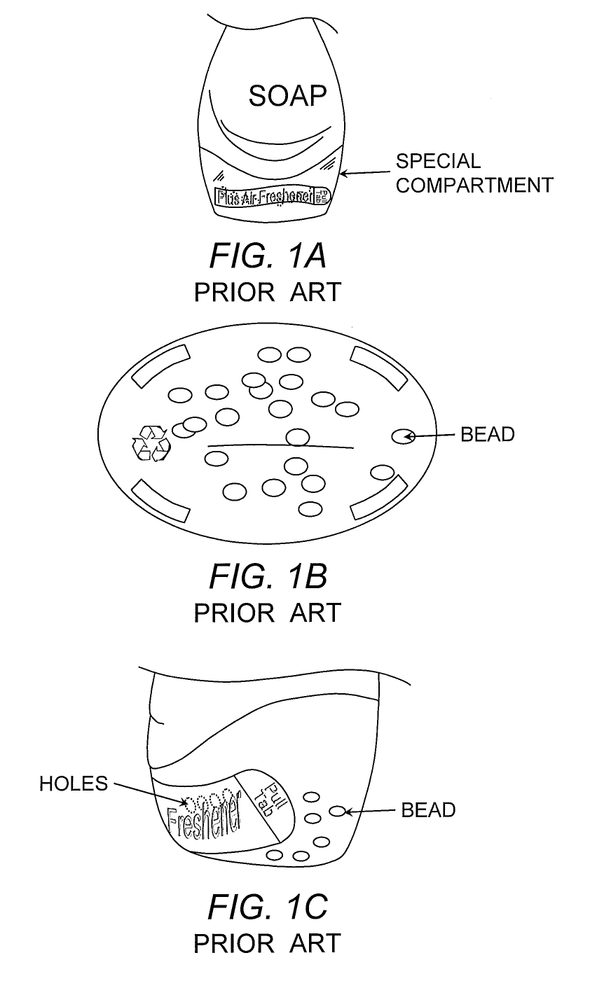

### DETAILED DESCRIPTION OF THE INVENTION

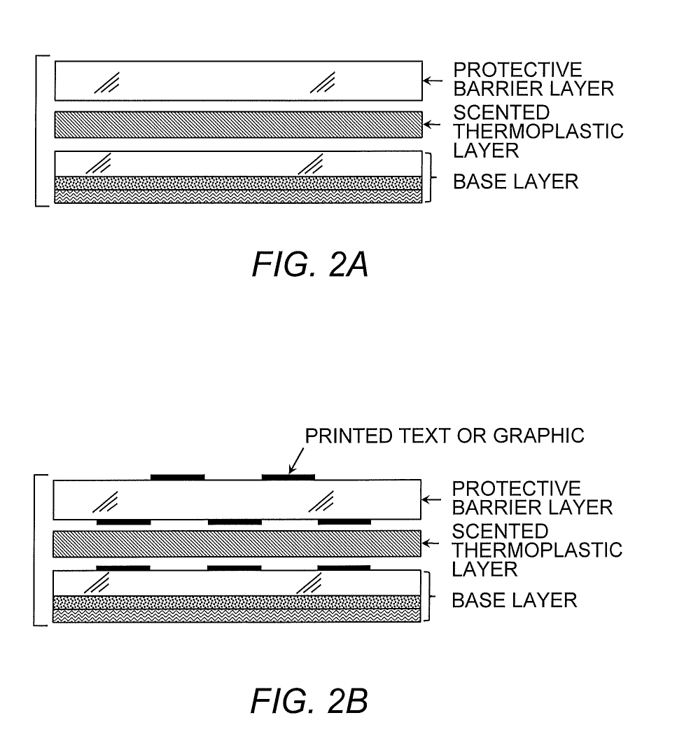

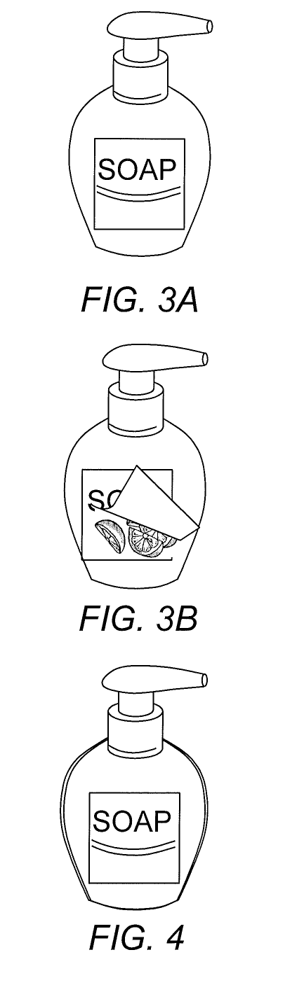

A scented label and a method for manufacture and use of the same have now been developed. A scented label of the present invention is composed of a scented thermoplastic resin applied to the upper surface of a pressure sensitive material or base layer (FIG. 2). To encase the fragrance in the scented thermoplastic layer until purchased by a consumer, the label further includes a removable protective skin or barrier film layer applied to the upper surface of the scented thermoplastic layer (FIG. 2 and FIG. 3). In some embodiments, one or both of the base layer and barrier layer contain text, a graphic and/or image, e.g., for product identification and/or decoration (FIG. 2B). The scented label of the invention finds application in allowing the consumer to use containers of soap, cleaners, lotions, detergents, and the like as air fresheners in kitchens and bathrooms. Accordingly, the present invention also features a method for producing a scented container by applying a scented label of the invention to the container.

The pressure sensitive material or base layer can be a single component structure or, as illustrated in FIG. 2, can be a multicomponent structure, e.g., a laminate film. Suitable materials for use as the base layer include, but are not limited to, the polyvinyl chloride (PVC), polystyrene, polyethylene, PETG (glycol modified PET polymer) and polyolefin families of film bases which provide a wide range of physical and performance film characteristics. Film characteristics play an important role in the selection of a particular film and may differ for each type of packaging or labeling application. Thus, the particular film base employed is readily selected by the skilled artisan based on the container or product and end use thereof.

The scented thermoplastic layer of the instant label is produced by mixing a concentrated solution of scent or fragrance (e.g., 50%, 60%, 70%, 80%, 90% or 95% floral or herbal oil) with a liquefied thermoplastic compound and subsequently applying said mixture to the base layer. Generally, thermoplastics are polymers that melt at high temperatures and solidify at low temperatures, thereby allowing for application to the surface of the base layer as a thin film. Thermoplastic polymers include TPE (thermoplastic elastomer), TPU (thermoplastic urethane), and PU (polyurethane), which, within a certain temperature range may be elastic as well as flexible. Thermoplastics are manufactured by numerous companies including Bayer Material Sciences, GLS Corporation, and Teknor Apex Corporation and can be applied to the instant base layer using conventional machinery. Desirably, the thermoplastic material selected will release the scent over a time period of at least one month.

The manufacture of chemically encapsulated fragrances or scents (often termed “microencapsulation”) is well known, and a wide variety of scents and fragrances can be employed within the scope of the embodiments of the present invention. Some general examples of the encapsulation/microencapsulation of fragrances/scents may be found in U.S. Pat. No. 4,605,554; U.S. Pat. No. 4,514,461; U.S. Pat. No. 4,495,509; U.S. Pat. No. 4,464,271; and U.S. Pat. No. 4,446,032.

Subsequent to the application of the scented thermoplastic to the base layer, a removable protective barrier layer is affixed to the upper surface of the scented thermoplastic layer to maintain the scent on the label until the time of removal of the barrier layer (FIG. 3). Any suitable polymer used in the preparation of barrier materials can be employed. For example, the barrier layer can be composed of polyethylene terephthalate (PET), amorphous polyethylene terephthalate (APET), cyclic olefin copolymers (COC), nylon, polyamide (PA), amorphous polyamide (APA), liquid crystalline polymers (LCP), ethylene vinyl alcohol copolymers (EVOH), silicon oxide (SiOx) or polyvinyl alcohol (PVOH), of which at least the two latter may possibly be applied on a thin carrier layer, such as, for example, paper, OPET, OPA or OPP. Suitably, it may have a thickness of between 5 and 20 μm, preferably between 5 and 15 μm. One or more such barrier layers may also be used to provide a laminate.

The layers of the instant label can optionally contain one or more tie layers of, for example, a binder or adhesive, for example an adhesion plastic such as ADMER available from Mitsui, Japan.

The entire structure of the instant pressure sensitive label (i.e., including the base layer, scented thermoplastic layer and removable protective layer) can be assembled prior to being applied to the container, or alternatively, each layer of the instant pressure sensitive label can be sequentially applied to the container.

Once the instant label is applied to the container (e.g., with a solvent, emulsion, or hot-melt adhesive), the labeled container is, in some embodiments, encapsulated with a shrink sleeve (FIG. 4) to prevent the deterioration of the fragrance until opened by the consumer. Any suitable shrink sleeve material and method can be used in accordance with the instant invention. See, e.g., U.S. 2003/0068453, U.S. Pat. No. 4,190,168 and U.S. Pat. No. 7,406,811.

What is claimed is:

1. A pressure sensitive label comprising a base layer, a layer of scented thermoplastic applied to the upper surface of the base layer and a removable, protective barrier layer applied to the upper surface of the scented thermoplastic layer.

2. The pressure sensitive label of claim 1, wherein the base layer comprises text, a graphic or image.

3. The pressure sensitive label of claim 1, wherein the protective barrier layer comprises text, a graphic or image.

4. A container comprising the pressure sensitive label of claim 1.

5. The container of claim 4, further comprising a shrink sleeve.

6. A method for producing a scented pressure sensitive label comprising applying a scented thermoplastic to the upper surface of a base layer and applying a protective barrier layer to the upper surface of the scented thermoplastic layer.

7. A method for producing a scented container comprising adhering the pressure sensitive label of claim 1 to a container thereby producing a scented container.

8. The method of claim 7, further comprising applying a shrink sleeve to the scented container.
